(19) United States
(12) Patent Application Publication
(10) Pub. No.: US 2017/0064720 A1
(43) Pub. Date: Mar. 2, 2017

(54) ROUTER AND METHOD FOR SELECTING CHANNEL

(71) Applicants: AMBIT MICROSYSTEMS (SHANGHAI) LTD., Shanghai (CN); HON HAI PRECISION INDUSTRY CO., LTD., New Taipei (TW)

(72) Inventor: SHIH-KUO YANG, New Taipei (TW)

(21) Appl. No.: 14/867,558

(22) Filed: Sep. 28, 2015

(30) Foreign Application Priority Data
Aug. 28, 2015 (TW) 104128247

(51) Int. Cl. H04W 72/08

(52) U.S. Cl. CPC H04W 72/082

(57) ABSTRACT

In a channel selection method executed at least one processor of a router having a wide area network port and a local area network port. The method includes calculating, at the router, which channel or channels are farthest from a channel that the wide area network port is currently accessing; a quantity of channels that are farthest from the channel that the wide area network port is accessing is determined; and the farthest channel is selected for the local area network to access when the quantity of the farthest channels is one.

### CROSS-REFERENCE TO RELATED APPLICATIONS

This application claims priority to Taiwanese Patent Application No. 104128247 filed on Aug. 28, 2015, the contents of which are incorporated by reference herein.

### FIELD

The subject matter herein generally relates to wireless communication technology, and particularly to a router and a method for selecting channels.

### BACKGROUND

In order to connect to a network, a network interface is required. A router can allow communication devices access to networks.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of a router.

FIG. 2 is a block diagram of an example embodiment of function modules of a channel selection system in the router of FIG. 1.

FIG. 3 illustrates a flowchart of an example embodiment of a method for selecting channels in the router of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

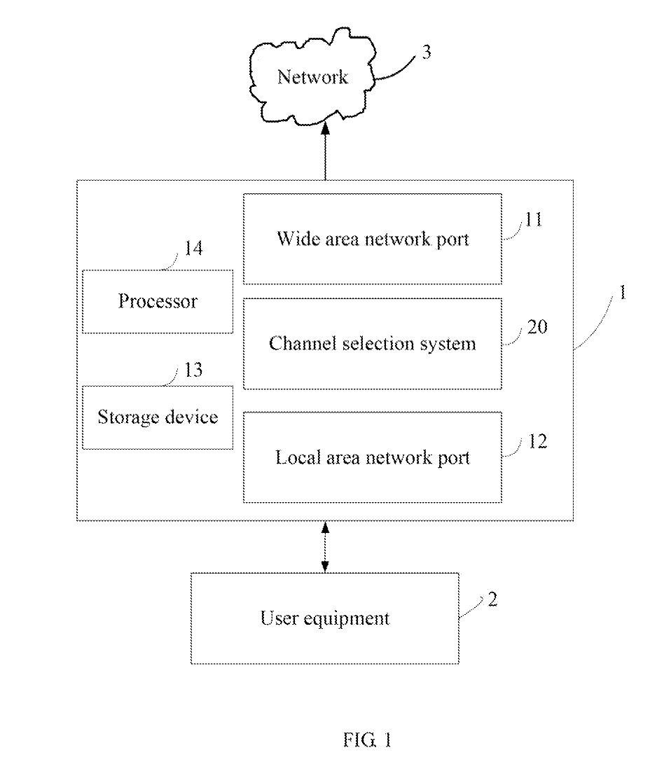

FIG. 1 is a block diagram of an example embodiment of a router. In at least the one embodiment shown in FIG. 1, the router 1 includes, but is not limited to, a wide area network (hereinafter referred to as WAN) port 11, a local area network (hereinafter referred to as LAN) port 12, a storage device 13, a processor 14 and a channel selection system 20. FIG. 1 illustrates only one example of the router, other examples can include more or fewer components than illustrated, or have a different configuration of the various components in other embodiments.

In at least one embodiment, the storage device 13 can include various types of non-transitory computer-readable storage mediums. For example, the storage device 13 can be an internal storage system, such as a flash memory, a random access memory (RAM) for temporary storage of information, and/or a read-only memory (ROM) for permanent storage of information. The storage device 13 can also be an external storage system, such as a hard disk, a storage card, or a data storage medium.

In at least one embodiment, the at least one processor 14 can be a central processing unit (CPU), a microprocessor, or other data processor chip that performs functions of the router 1.

In at least one embodiment, the WAN port 11 can connect an external network 3 (for example, an Ethernet network or an Asymmetric digital subscriber line). The LAN port 12 can connect a local network and one or more user equipment 2. The user equipment 2 can access the Internet via the LAN port 12. In some embodiments, the user equipment 2 can be mobile phone, a computer, or any other electronic device which is capable of communication.

In some embodiments, the router 1 can be only a wireless access point, or only a base station. In some embodiments, the router 1 can be a wireless access point and a base station. For example, the WAN port 11 can be the wireless access point for the user equipment to access the Internet. The LAN port 12 can be the base station for the router 1 to communicate with a host server or the other routers.

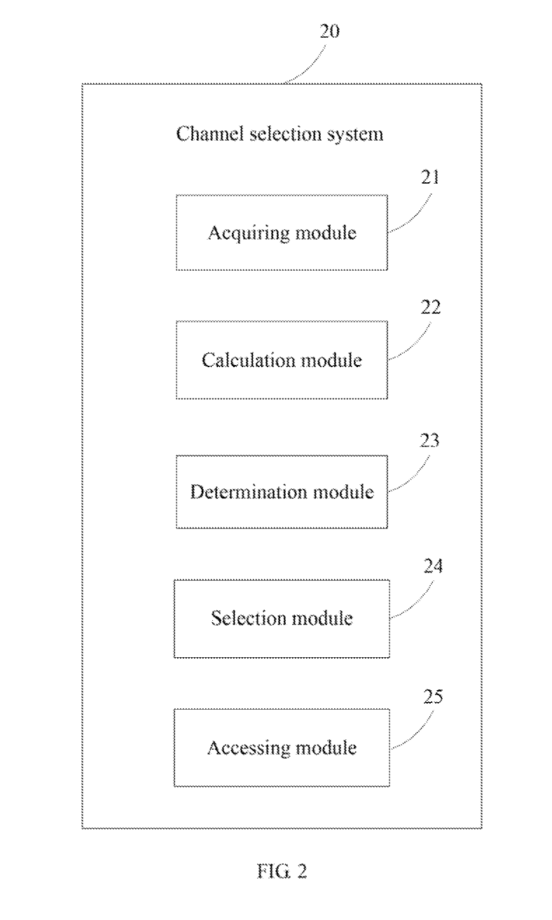

FIG. 2 is a block diagram of an exemplary embodiment of function modules of the channel selection system in the router of FIG. 1. In at least one embodiment, the channel selection system 20 can include an acquiring module 21, a calculation module 22, a determination module 23, a selection module 24, and an accessing module 25. The function modules 21, 22, 23, 24, and 25 can include computerized codes in the form of one or more programs which are stored in the storage device 13. The at least one processor 14 executes the computerized codes to provide functions of the function modules 21-25.

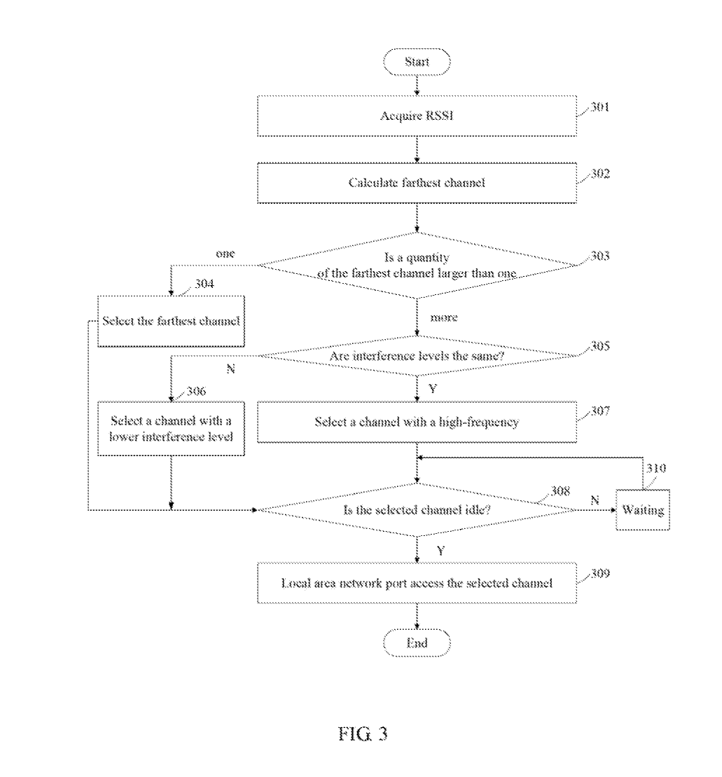

FIG. 3 illustrates a flowchart in accordance with an exemplary embodiment. An exemplary method 300 is provided by way of example, as there are a variety of ways to carry out the method. The exemplary method 300 described below can be carried out using the configurations illustrated in FIG. 1 and FIG. 2, and various elements of these figures are referenced in explaining the example method. Each block shown in FIG. 3 represent one or more processes, methods, or subroutines carried out in the exemplary method 300. Furthermore, the illustrated order of blocks is illustrative only and the order of the blocks can be changed. The exemplary method 300 can begin at block 301. Depending on the embodiment, additional blocks can be utilized and the ordering of the blocks can be changed.

At block 301, an acquiring module acquires a received signal strength indicator from every channel.

In at least one embodiment, there can be eleven available channels for transmitting wireless signals. The eleven available channels can be named from number 1 to number 11 respectively. That is to say, the different channels can be distinguished by channel number in an increasing order. The received signal strength indicator (hereinafter referred to as RSSI) can be a quality parameters represents an interference level of the channel.

When wireless communication devices are activated and access the available channels, the wireless communication devices can send broadcast signals periodically (e.g., 120 milliseconds).

The acquiring module can scan each channel within predetermined time duration and acquire broadcast signals from the wireless communication devices. The broadcast signals can comprise a channel number in accordance with a channel accessed by the wireless communication devices, source address, and the RSSI.

At block 302, a calculation module calculates which channel or channels are farthest from a channel that the WAN port 11 is currently accessing.

In some embodiments, the calculation module calculates the farthest channel by calculating a difference of channel number between a first channel number and a second channel number. The first channel number can be in accordance with a channel that the WAN port 11 is currently accessing. The second channel number can be in accordance with channels that the wireless communication devices are currently accessing.

Take an example, the WAN port 11 is currently accessing the channel 6. A difference of channel number between the channel 6 and the channel 1 is 5. A difference of channel number between the channel 6 and the channel 11 is 5. A difference of channel number between the channel 6 and the channel 3 is 3. The calculation module determines that the farthest channels are channel 1 and channel 11.

At block 303, a determination module determines whether a quantity of channels that are farthest from the channel that the wide area network port is accessing is one. If a determination is made that the quantity of the farthest channels is one, the process goes to block 304; if a determination is made that the quantity of the farthest channels is larger than one, the process goes to block 305.

For example, the calculation module determines that the farthest channels are channel 1 and channel 11; the determination module determines that the quantity is two. The process goes to block 305.

At block 304, a selection module selects the farthest channel for the LAN port 12 to access. For example, the WAN port 11 is currently accessing channel 1, then the calculation module determines that the farthest channel is channel 11, the selection module selects channel 11 for the LAN port 12 to access.

At block 305, a determination module determines whether an interference level of the two farthest channels is the same. If a determination is made that the interference level of the farthest channels is not the same, the process goes to block 306; if a determination is made that the interference level of the farthest channel is the same, the process goes to block 307.

In some embodiments, the determination module determines the interference level according to a corresponding relationship between interference levels and the RSSI. The corresponding relationship between interference levels and the RSSI can be stored in the storage device 13 or a server corresponding to the router 1. For example, when the RSSI is eighty decibels, the corresponding interference level is ten. When the RSSI is seventy decibels, the corresponding interference level is nine. It should be emphasized that, if there is only one wireless communication device accessing the channels, the determination module determines the interference level according to the RSSI sent by the only one wire communication device. If there are more than one wireless communication devices accessing the channels, the determination module determines the interference level according to a sum of the RSSIs.

At block 306, a selection module selects a channel with a lower interference level for the LAN port 12 to access.

As shown the example above, the WAN port 11 is currently accessing the channel 6. The farthest channels are channel 1 and channel 11. The interference level of the channel 1 is 6, and the interference level of the channel 11 is 8. The selection module selects channel 1 for the LAN port 12 to access.

At block 307, the selection module selects a channel with a high-frequency for the LAN port 12 to access.

In some embodiments, a channel with a highest-frequency is a channel with a largest number. For example, a high-frequency of the channel 11 is larger than a high-frequency of the channel 1.

Take as an example, if the WAN port 11 is currently accessing the channel 6. The farthest channels are channel 1 and channel 11. The interference levels of the channel 6 and the channel 11 are the same. The selection module selects channel 11 for the LAN port 12 to access.

At block 308, a determination module determines whether the selected channel is idle. If a determination is made that the selected channel is idle, the process goes to block 309; if a determination is made that the selected channel is not idle, the process goes to block 310.

At block 309, an accessing module establishes a connection between the LAN port 12 and the selected channel.

At block 310, waiting for a predetermined duration (e.g., 0.5 millisecond), and the process returns to block 307.

The example method 300 can be used when the router 1 is activated. The example method 300 can access the LAN port 12 to the selected channel. Alternatively, the example method 300 can be used when the router 1 is working normally, but a physical address of the router 1 is changing, the example method 300 can change to another channel for the LAN port 12 to access.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for selecting one or more channels being executed by at least one processor of a router, the router comprising a wide area network port and a local area network port, the method comprising:
calculating, at the router, which channel or channels are farthest from a channel that the wide area network port is currently accessing;
determining, at the router, a quantity of channels that are farthest from the channel that the wide area network port is accessing; and
selecting, at the router, the farthest channel for the local area network to access when the quantity of the farthest channels is one.

2. The method according to claim 1, further comprise:
selecting, at the router, a channel with a lower interference level for the local area network to access, when the quantity of the farthest channels is two.

3. The method according to claim 2, further comprise:
selecting, at the router, a channel with a highest frequency for the local area network to access, when the quantity of the farthest channels is two and the interference levels of the two farthest channels are the same.

4. The method according to claim 3, wherein the interference level is determined according to a corresponding relationship between interference levels and RSSIs acquired from each channel.

5. The method according to claim 3, wherein the channel with a highest frequency is a channel with a largest number.

6. The method according to claim 5, wherein the number is used to distinguish the channels and in an increasing order.

7. A router, comprising:
a wide area network port;
a local area network port; and
a storage device storing one or more programs, which when executed by at least one processor of the router cause the at least one processor to:
calculate, at the router, which channel or channels are farthest from a channel that the wide area network port is currently accessing;
determine, at the router, a quantity of channels that are farthest from the channel that the wide area network port is accessing; and
select, at the router, the farthest channel for the local area network to access when the quantity of the farthest channel is one.

8. The router according to claim 7, further comprise:
select, at the router, a channel with a lower interference level for the local area network to access, when the quantity of the farthest channels is two.

9. The router according to claim 8, further comprise:
select, at the router, a channel with a highest frequency for the local area network to access, when the quantity of the farthest channels is two and the interference level of the two farthest channels are the same.

10. The router according to claim 9, wherein the interference level is determined according to a corresponding relationship between interference levels and RSSIs acquired from each channel.

11. The router according to claim 9, wherein the channel with a highest frequency is a channel with a largest number.

12. The router according to claim 11, wherein the number is used to distinguish the channels and in an increasing order.

13. A non-transitory storage medium having stored thereon instructions that, when executed by a processor of an router, causes the processor to perform a channel selection method using the router, the router comprising a wide area network port and a local area network port, the method comprising:
calculating, at the router, which channel or channels are farthest from a channel that the wide area network port is currently accessing;
determining, at the router, a quantity of channels that are farthest from the channel that the wide area network port is accessing; and
selecting, at the router, the farthest channel for the local area network to access when the quantity of the farthest channels is one.

14. The non-transitory storage medium according to claim 13, further comprise:
selecting, at the router, a channel with a lower interference level for the local area network to access, when the quantity of the farthest channels is two.

15. The non-transitory storage medium according to claim 14, further comprise:
selecting, at the router, a channel with a highest frequency for the local area network to access, when the quantity of the farthest channels is two and the interference level of the two farthest channels are the same.

16. The non-transitory storage medium according to claim 15, wherein the interference level is determined according to a corresponding relationship between interference levels and RSSIs acquired from each channel.

17. The non-transitory storage medium according to claim 15, wherein the channel with a highest frequency is a channel with a largest number.

18. The non-transitory storage medium according to claim 17, wherein the number is used to distinguish the channels and in an increasing order.
